(19) United States
(12) Patent Application Publication
(10) Pub. No.: US 2007/0006928 A1
(43) Pub. Date: Jan. 11, 2007

(54) Tapered Expansion Plug with Seating Flange

(76) Inventor: Steven Meserlian, North Caldwell, NJ (US)

Correspondence Address: SHOEMAKER AND MATTARE, LTD, 10 POST OFFICE ROAD - SUITE 110, SILVER SPRING, MD, 20910, US

(21) Appl. No.: 11/456,762

(22) Filed: Jul. 11, 2006

Related U.S. Application Data
(60) Provisional application No. 60/698,151, filed on Jul. 11, 2005.

(51) Int. Cl. F16L 55/10

(52) U.S. Cl. 138/89

(57) ABSTRACT

A tapered expansion plug for winterizing swimming pools has a peripheral flange at its larger end, to enable one to seat the plug properly in a return line when operating “blind”. The plug is expanded by turning a wing nut after the plug has been properly seated.

This application claims benefit under 35 USC 119(e) from provisional patent application 60/698151, filed Jul. 11, 2005.

### BACKGROUND OF THE INVENTION

This invention relates to a tapered expansion plug with a seating flange.

Swimming pools are “winterized” in colder climates to protect the pool and its plumbing from the expansion of water as it freezes. One of the steps normally done by a maintenance crew is to blow out water from the water return lines which lead from the pool to the pump, and then to insert a plug at the pool end of the line to keep water out during the winter.

Tapered plugs, and expandible plugs, are known for the purpose of sealing swimming pool return lines. An advantage of a tapered plug is that it is more easily inserted into the return line, whose open end is typically in a blind location on the pool wall with respect to the mechanic attempting to insert it while reaching over the edge of the pool. Experience shows, however, that simple tapered plugs sometimes get seated in a cocked position (where the axis of the plug is at an angle to the axis of the return line). Good sealing does not result when the plug is cocked, particularly where the inside of the return line is threaded. A reason why simple tapered plugs are not easily seated properly is that they do not provide any tactile feedback indicative of when the plug is aligned with the line.

Expandible plugs improve sealing and plug security by allowing one first to seat the plug, then increase its diameter by appropriate manipulation. A typical expandible plug can be made out of a rubber disc sandwiched between two large washers. A nut is then tightened on a bolt passing through the sandwich, reducing its height and increasing the diameter of the disc. Expansion may reduce the negative effects of improper plug seating, but is no substitute for getting the plug aligned with the return line and properly seated in the first place.

### SUMMARY OF THE INVENTION

An object of the invention is to provide a plug which is more easily and more reliably properly seated in the end of a swimming pool water return line.

These and other objects are attained by a tapered expansion plug having a peripheral flange, as described below.

### BRIEF DESCRIPTION OF THE DRAWINGS

In the accompanying drawings,

FIG. 1 is an exploded perspective view of a tapered expansion plug embodying the invention;

FIG. 2 is a section view of the plug shown in FIG. 1, taken along the axis of the plug;

FIG. 3 is a perspective view of an alternative form of the plug; and

FIG. 4 shows the plug being inserted into the end of a swimming pool return line.

### DESCRIPTION OF THE PREFERRED EMBODIMENT

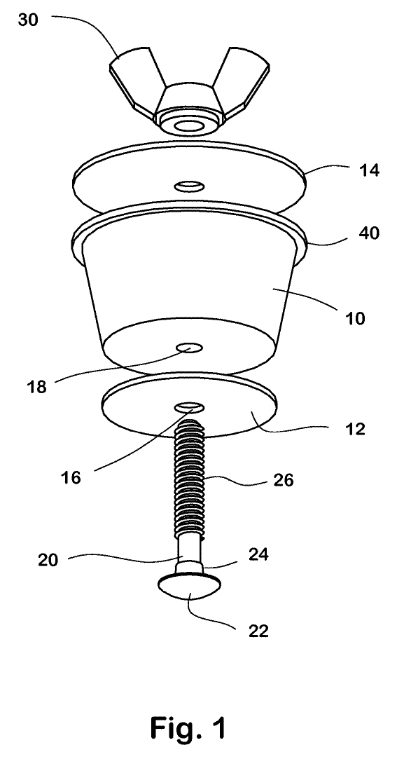

As shown in FIG. 1, a tapered expansion plug embodying the invention comprises a generally frustoconical rubber disk 10 sandwiched between a first washer 12 and a second washer 14. Although the second washer is illustrated as larger than the first washer, the washers could be the same size. The rubber is sufficiently flexible that it can be expanded substantially by axially compressing the disk.

The washers have center holes, that of the first washer being designated by reference number 16. The rubber disk has a slightly smaller diameter through hole 18 extending along its longitudinal axis. A bolt 20 extends through the holes of the disk and the washers. The bolt has an enlarged head 22, a tapered portion 24 adjacent the head, and a threaded shank 26. A wing nut 30, having complementary threads, is tightened onto the threaded end of the shank to compress the disk. The wing nut could be made of various including nylon or suitable metals. Alternatively, the wing nut could be replaced by any type of nut. The tapered portion 24 has a mean diameter about equal to that of the hole 18 in the washer adjacent the smaller side of the disk, so that it wedges in the hole as the nut is tightened. This wedging transfers torque from the bolt to the smaller washer, which bears against the rubber disk with increasing force as the nut is tightened, thus keeping the bolt from turning in the hole.

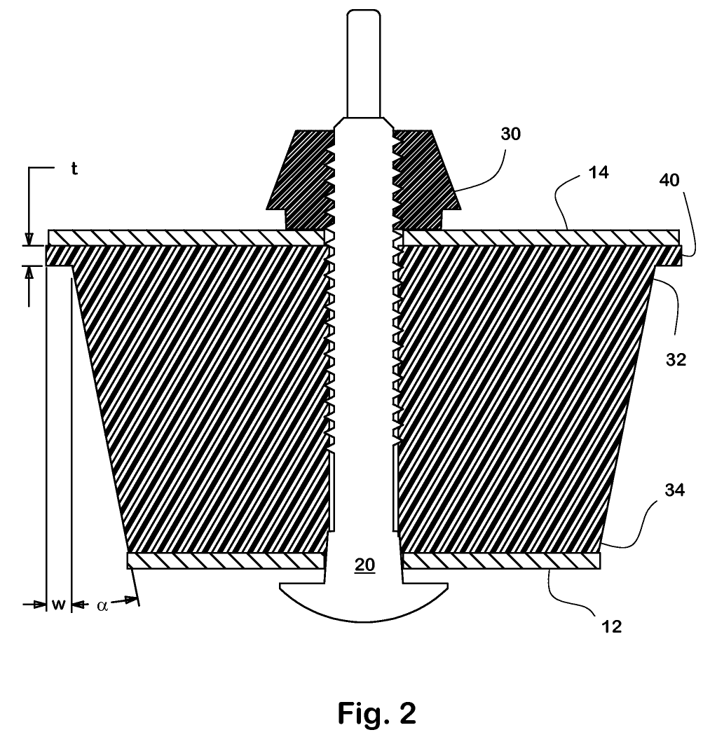

As best seen in FIG. 2, the plug is tapered, from its larger end 32 to its smaller end 34. The preferred taper angle α is between 3° and 17°. Angles in this range have been found to provide the best combination of ease of insertion and retention security.

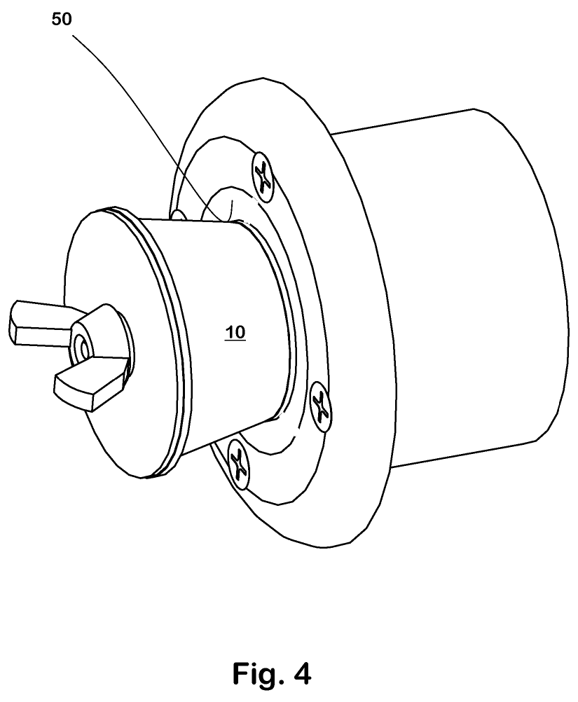

A peripheral flange 40 is integrally formed around the larger end 32 of the plug. The flange has a preferred thickness “t” (FIG. 4) in the axial direction in the range of 0.030 to 0.100 inch, most preferably about 0.065 inch. The flange's width “w” in the radial direction, from its inner diameter, where it meets the tapered face of the plug, to its outside diameter, is preferably about 0.060-0.205 inch.

The optimum dimensions, which are given for one plug, may vary according to the intended application, and may depend somewhat on the size of the plug, on a proportional basis. Different applications may require different plug sizes, and different flange dimensions.

The flange washer 14 should have an outer diameter not larger than that of the flange, yet large enough to prevent the plug from being pushed or sucked into the opening. I prefer that the flange washer 14 have an outer diameter equal to or less than that of the flange's outer diameter, but greater than the flange's inner diameter.

In a variation of the invention, not shown in the drawings, the wing nuts are dyed different colors to identify the plugs by size. Alternatively, any component of the plug could be the one color-coded.

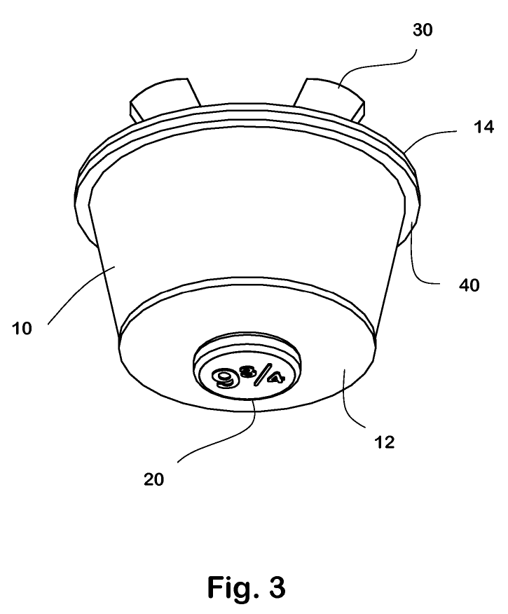

In another variation of the invention, shown in FIG. 3, the plug size is stamped on the bolt head. The mechanic can thus quickly distinguish between plugs of nearly equal size.

Plugs are sized according to diameter as shown in the table below.

| No. | D (inch) | Used For |
|---|---|---|
| 000 | 0.46 | ⅜″ P |
| 00 | 0.54 | ½″ P |
| 0 | 0.63 | ½″ P |
| 1 | 0.70 | ½″ P |
| 2 | 0.75 | ¾″ T |
| 3 | 0.89 | ¾″ T |
| 4 | 0.96 | ¾″ T; 1″ P |
| 5 | 1.02 | 1″ T |
| 5½ | 1.06 | 1″ P |
| 6 | 1.20 | 1″ F |
| 6½ | 1.27 | 1¼″ P |
| 7 | 1.39 | 1¼″ P |
| 7½ | 1.46 | 1½″ P |
| 8 | 1.54 | 1½″ P |
| 8½ | 1.62 | 1½″ P |
| 9 | 1.69 | 1½″ P; 1¼″ F |
| 9½ | 1.73 | 1½″ F |
| 10 | 1.89 | 1½″ F |
| 10½ | 2.01 | 2″ P |
| 11 | 2.13 | 2″ P |
| 11½ | 2.35 | 2½″ P |
| 12 | 2.42 | 2″ F |
| 13 | 2.58 | 2½″ P |
| 13½ | 2.82 | 3″ P |
| 13¾ | 3.02 | 3″ Sch. 40 P |
| 14 | 3.40 | 3″ P |
| 15 | 3.86 | 4″ P |
| 16 | 4.64 | 4″ P |

P = Pipe
T = Tube
F = Fitting
D = diameter of stopper ¾ of its height from smaller end

In use, the pool mechanic selects a plug whose larger end (not including the flange) is as large end or slightly larger than the return line opening 50 (FIG. 4). He then pushes the plug into the opening until he feels abrupt resistance, as the flange makes 360° contact with the opening, so that the axis of the plug lies on the axis of the opening. Now, knowing the plug is properly seated, the mechanic turns the wing nut clockwise to increase the diameter of the rubber disk sufficiently to keep the plug from coming out of the opening, and to form a tight seal notwithstanding any helical threads formed inside the opening, or other irregularities which might otherwise result in leakage.

Another advantage of the peripheral flange is that it makes face-to-face contact with the face plate around the return line opening, closing the path to any fluid that might leak along threads formed in the return line.

It should be understood that the foregoing is a preferred embodiment, but that the invention may take other forms. For example, while the preferred shape of the plug is, as shown in the drawings, round (that is, circular in cross-section), the principles of the invention could be applied to a tapered plug of a shape other than round, for example elliptical or polygonal, to plug corresponding holes.

Since the invention is subject to modifications and variations, it is intended that the foregoing description and the accompanying drawings shall be interpreted as only illustrative of the invention defined by the following claims.

I claim:

1. A tapered expansion plug for sealing swimming pool return lines, said plug comprising
a disk made of a compressible material,
means for compressing the disk axially so as to expand the disk laterally, and further comprising
a peripheral flange extending outward from said disk at its larger end to facilitate proper seating of the plug in a return line opening.

2. The invention of claim 1, wherein the disk is tapered from one end to the other at a taper angle when the disk is uncompressed.

3. The invention of claim 1, wherein the taper angle is in the range of 3° to 17°.

4. The invention of claim 1, wherein the flange has an axial thickness in the range of 0.030 -0.100 inch.

5. The invention of claim 1, wherein the flange has an axial thickness of about 0.065 inch.

6. The invention of claim 1, wherein the flange has a radial width in the range of 0.060-0.205 inch.

7. The invention of claim 1, wherein the compressing means comprises
a pair of washers, one on either side of said disk,
said disk and said washers each having a central hole,
a bolt extending through said central holes, said bolt having a head and a threaded shank,
a nut rotatably engaged with said threaded shank and bearing against one of said washers, whereby, when the nut is tightened, the disk is compressed axially and expands in diameter.

8. The invention of claim 7, wherein the bolt has a head and a tapered portion adjacent the head, the tapered portion having a mean diameter about equal to the diameter of the hole in the washer adjacent the smaller end of the disk, whereby the tapered portion wedges in the hole when the nut is tightened to prevent the bolt from turning in the hole.

9. The invention of claim 7, wherein the flange has an unexpanded outside diameter not less than the outside diameter of the flange washer.

10. The invention of claim 9, wherein the outside diameter of the flange washer is greater than the inside diameter of the peripheral flange.

11. The invention of claim 1, wherein the disk is circular in cross-section.
